(19) United States
(12) Patent Application Publication
(10) Pub. No.: US 2024/0378701 A1
(43) Pub. Date: Nov. 14, 2024

(54) ELECTRONIC DEVICE AND METHOD WITH IMAGE NOISE REMOVAL

(71) Applicants: SAMSUNG ELECTRONICS CO., LTD., Suwon-si (KR); Gwangju Institute of Science and Technology, Gwangju (KR)

(72) Inventors: Seokpyo HONG, Suwon-si (KR); Bochang MOON, Gwangju (KR); Nahyup KANG, Suwon-si (KR); Hajin CHOI, Gwangju (KR); Inwoo HA, Suwon-si (KR)

(73) Assignees: SAMSUNG ELECTRONICS CO., LTD., Suwon-si (KR); Gwangju Institute of Science and Technology, Gwangju (KR)

(21) Appl. No.: 18/652,278

(22) Filed: May 1, 2024

(30) Foreign Application Priority Data
May 9, 2023 (KR) 10-2023-0059863

(51) Int. Cl. G06T 5/60; G06T 5/70; G06T 15/00; G06T 15/20

(52) U.S. Cl. CPC G06T 5/60; G06T 5/70; G06T 15/005; G06T 15/20

(57) ABSTRACT

An electronic device and operating method for removing a noise of an image are disclosed. A method of operating an electronic device includes generating a common input including an initial image and geometry buffer (G-buffer) images rendered according to a view point of a current frame, generating a third input and a fourth input based on a first input and a second input, determining a bandwidth for filtering noise of the initial image based on the common input and one of the third input and the fourth input, and outputting a target image obtained by removing noise from the initial image of the current frame based on the common input, the third input, the fourth input, and the bandwidth.

### CROSS-REFERENCE TO RELATED APPLICATIONS

This application claims the benefit under 35 USC § 119 (a) of Korean Patent Application No. 10-2023-0059863, filed on May 9, 2023, in the Korean Intellectual Property Office, the entire disclosure of which is incorporated herein by reference for all purposes.

### BACKGROUND

### 1. Field

The following description relates to an electronic device and method with image noise removal, and more particularly, with linear regression and block reconstruction.

### 2. Description of Related Art

Ray tracing-based rendering technologies (e.g., path tracing) create realistic images using physical properties of light. Ray tracing is used to create realistic graphics for use in movies, animations, and advertisements. However, it is difficult to apply the path tracing, which is a de facto standard in applications such as a metaverse, augmented reality, etc., where images are generated in real time.

This limitation of real-time rendering is because ray tracing simulates a path of light using Monte Carlo integration, however, due to statistical limitations on computation, simulating only a small number of paths/samples per pixel of a rendered image may cause noise to be included in the image. When the number of samples per pixel is increased, the noise may be reduced, but the time for rendering, which is proportional to the number of samples, increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of operating an electronic device includes generating a common input including an initial image and geometry buffer (G-buffer) images rendered according to a view point of a current frame, generating a third input by reprojecting, onto the view point, a result obtained by adding an initial image, that is rendered in a prior frame that is prior to the current frame, to a first image, wherein the first image is one of a first input generated in the prior frame and a second input generated in the prior frame, generating a fourth input by reprojecting, onto the view point, a second image, wherein the second image is whichever of the other one of the first input and the second is not the first image, determining a bandwidth for filtering a noise of the initial image, wherein the bandwidth is determined based on the common input and one of the third input and the fourth input, and outputting a target image obtained by removing noise from the initial image of the current frame based on the common input, the third input, the fourth input, and the bandwidth.

Each of the third input and the fourth input may include a respective history image in which images of frames prior to the current frame are accumulated.

The view point of the current frame may be different from a view point of rendering the prior frame.

The outputting of the target image may include outputting linear regression models using the third input, the fourth input, and the common input as inputs, and outputting the target image through block reconstruction based on the plurality of linear regression models and the bandwidth.

The method may further include outputting a reference image for comparison with the target image, and the outputting may be based on the common input, the third input, and the fourth input.

The outputting of the reference image may include outputting linear regression models using the common input, the third input, and the fourth input as inputs, and outputting the reference image through block reconstruction based on the linear regression models.

The method may further include calculating a loss between the target image and the reference image, and updating a neural network of the current frame used to output the target image by backpropagating the loss, wherein the neural network of the current frame outputs the bandwidth.

The updated neural network of the current frame may be used to output a target image of a next frame in the next frame of the current frame.

The target image may be an image, from which the noise is removed, compared to the reference image.

The outputting of the linear regression models may include determining a number of the linear regression models based on a size of the initial image of the common input and a size of a sparsity block, and outputting linear regression coefficients for the linear regression models, respectively.

The noise of the target image may be further reduced as the size of the sparsity block decreases.

The outputting of the target image through the block reconstruction may include outputting the target image based on a size of a block reconstruction window indicating a number of pixels to be output by one linear regression model.

In another general aspect, a method of operating an electronic device includes generating a common input including an initial image and G-buffer images rendered according to a view point of a current frame, generating a third input and a fourth input of the current frame from a first input, a second input, and an initial image generated in a prior frame that is prior to the current frame, determining a bandwidth for filtering a noise of the initial image based on the common input and one of the third input and the fourth input, outputting a target image obtained by removing noise from the initial image of the current frame based on the common input, the third input, the fourth input, and the bandwidth, outputting a reference image of the current frame for comparison with the target image based on the common input, the third input, and the fourth input, and updating a neural network used to output the target image, where the updating is performed by calculating a loss between the target image and the reference image.

In still another general aspect, an electronic device includes a processor configured to generate a common input including an initial image and G-buffer images rendered according to a view point of a current frame, generate a third input by reprojecting, onto the view point, a result obtained by adding an initial image, which is rendered in a prior frame prior to the current frame, to a first image that is one of a first input generated in the prior frame or a second input generated in the prior frame, generate a fourth input by reprojecting, onto the view point, a second image that is whichever of the first input and the second input generated in the prior frame is not the first image, determine a bandwidth for filtering a noise from the initial image based on the common input and one of the third input or the fourth input, and output a target image obtained by removing noise from the initial image of the current frame based on the common input, the third input, the fourth input, and the bandwidth.

Each of the third input and the fourth input may include a respective history image in which images of prior frames prior to the current frame are accumulated.

The view point of the current frame may be different from a view point of the prior frame.

The processor may be configured to output linear regression models using the third input, the fourth input, and the common input as inputs, and output the target image through block reconstruction based on the linear regression models and the bandwidth.

The processor may be configured to output a reference image for comparison with the target image based on the common input, the third input, and the fourth input.

The processor may be configured to output linear regression models using the common input, the third input, and the fourth input as inputs, and output the reference image through block reconstruction based on the plurality of linear regression models.

The processor may be configured to calculate a loss between the target image and the reference image, and update a neural network of the current frame used to output the target image by backpropagating the loss, and wherein the neural network of the current frame outputs the bandwidth.

Other features and aspects will be apparent from the following detailed description, the drawings, and the claims.

### BRIEF DESCRIPTION OF THE DRAWINGS

FIG. 1 illustrates an example of an electronic device, according to one or more embodiments.

FIG. 2 illustrates example operations of an electronic device, according to one or more embodiments.

FIG. 3 illustrates example operations an operation of an electronic device, according to one or more embodiments.

FIG. 4 illustrates an example of reprojection, according to one or more embodiments.

FIG. 5 illustrates an example of generating a history image of a current image, according to one or more embodiments.

FIGS. 6 and 7 illustrate examples of generating a target image and a reference image, according to one or more embodiments.

FIG. 8 illustrates an example of a linear regression model and a block size used for block reconstruction, according to one or more embodiments.

FIG. 9 illustrates an example of updating a neural network, according to one or more embodiments.

FIG. 10 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

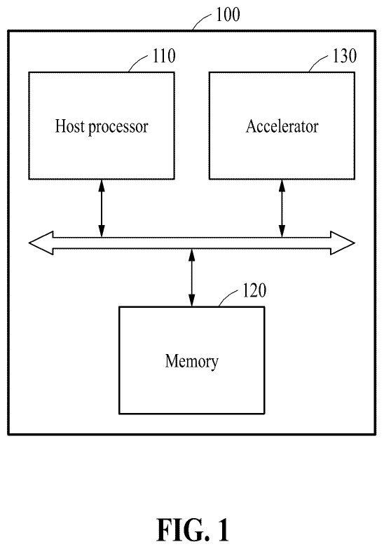

FIG. 1 illustrates an example electronic device, according to one or more embodiments.

Referring to FIG. 1, an electronic device 100 may include a host processor 110, a memory 120, and an accelerator 130. The host processor 110, the memory 120, and the accelerator 130 may communicate with each other through a bus, a network on a chip (NoC), a peripheral component interconnect express (PCle), or the like. In the example of FIG. 1, components related to the examples described herein are illustrated as being included in the electronic device 100. Thus, the electronic device 100 may also include other general-purpose components, in addition to the components illustrated in FIG. 1.

The host processor 110 may perform overall functions for controlling the electronic device 100. The host processor 110 may control the electronic device 100 by executing programs, including an operating system, and/or instructions stored in the memory 120. The host processor 110 may be implemented as a central processing unit (CPU), a graphics processing unit (GPU), an application processor (AP), and/or the like, that are included in the electronic device 100, however, examples are not limited thereto.

The memory 120 may be hardware for storing data processed in the electronic device 100 and data to be processed. In addition, the memory 120 may store an application, a driver, and the like to be driven by the electronic device 100. The memory 120 may include a volatile memory (e.g., dynamic random-access memory (DRAM)) and/or a nonvolatile memory.

The electronic device 100 may include a hardware accelerator 130 for an operation. The accelerator 130 may perform certain process tasks more efficiently than the general-purpose host processor 110, due to characteristics of the tasks. Here, one or more processing elements (PEs) included in the accelerator 130 may be utilized. The accelerator 130 may be, for example, a neural processing unit (NPU), a tensor processing unit (TPU), a digital signal processor (DSP), a GPU, a neural engine, or the like that may perform an operation according to a neural network.

A processor described below may be implemented as the accelerator 130, however, examples are not limited thereto; the processor may also be implemented as the host processor 110.

The processor may generate a common input rendered according to a view point of a current frame (“common” referring to the potential to serve as an input to different components). The common input of the current frame may include an initial image and geometry buffer (G-buffer) images. Rendered images included in the common input may be rendered using ray tracing. The processor may generate a third input and a fourth input of the current frame based on color images included in inputs of a prior frame. The color images included in the inputs of the prior frame may include an initial image, a first history image, and a second history image of the prior frame. The processor may output a target image and a reference image of a current image based on the common input, the third input, and the fourth input of the current frame. The target image may be an image from which noise is removed. The reference image may be an image used to calculate a loss in relation to the target image. The processor may calculate the loss using the target image and the reference image. The processor may use the calculated loss to update a neural network used to generate the target image. The updated neural network may be used to update a target image of a next frame when processing the next frame. Only the target image from which noise is removed may be displayed on a screen.

In other words, the processor may remove noise from an image, and may do so using a neural network updated in real time. The processor may update the neural network in real time in the current frame and use the neural network to generate the target image of the next frame.

Operation of the electronic device 100, specifically, the processor, are described next.

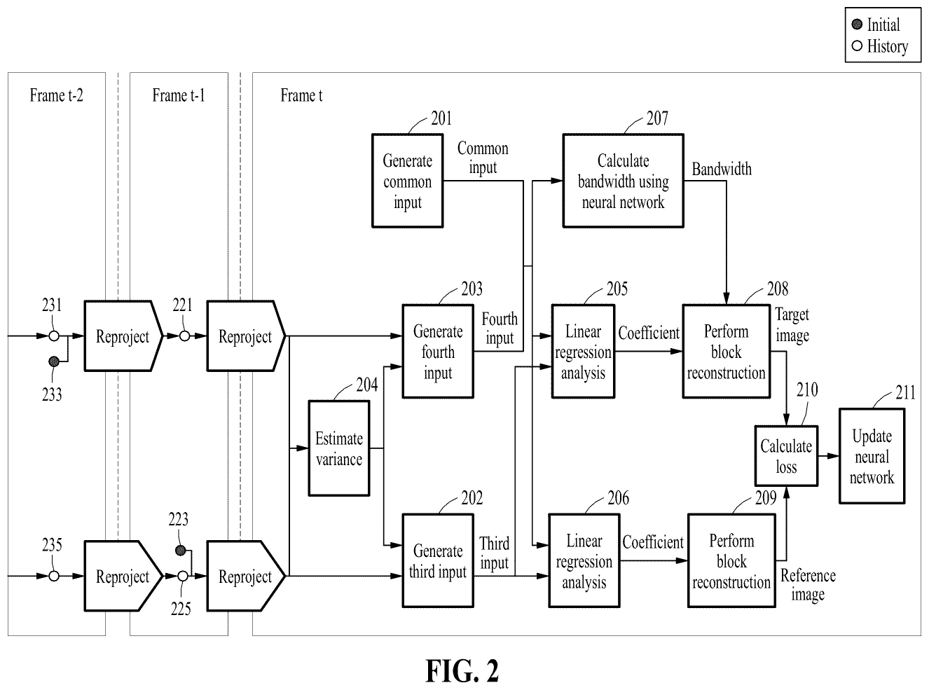

FIG. 2 illustrates example operations of an electronic device, according to one or more embodiments.

FIG. 2 shows a method of removing noise of an initial image rendered in frame t (which is the current frame), and updating the aforementioned neural network. When frame t is the current frame, then frame t−1 is the prior frame (prior to the current frame), and frame t−2 is one frame before (prior to) the prior frame.

In operation 201, the processor may generate a common input by rendering objects included in a three-dimensional (3D) scene of the current frame according to a view point of the current frame. The processor may generate the common input by ray tracing.

The common input may include an initial image and G-buffer images rendered according to the view point of the current frame. The initial image may be a color image (e.g., a red, green, and blue (RGB) image). The G-buffer images may include geometric information of objects included in the 3D scene. Specifically, the G-buffer images may include, but are not limited to, a depth map, an albedo map, a specular map, and/or a normal map. A G-buffer image may be defined in various ways according to the purpose of use.

In the following, first history images 231 and 221 may be history images (of respective previous frames) that were previously inputted to the neural network. Second history images 235 and 225 may be images (of the respective previous frames) that were not previously inputted to the neural network.

A first input of the prior frame (prior with respect to the current frame) may include/be the first history image 221, which, among various inputs of (used to render) the prior frame, was inputted to the neural network. A second input of the prior frame may include/be the second history image 235, which, among the various inputs of the prior frame, was not inputted to the neural network.

When the current frame was frame t−1, the frame t was the next frame, and the frame t−2 was the prior frame. In addition, the first input (of frame t−1) may have included/been the first history image 231, and the second input (of frame t−1) may have included/been the second history image 235.

Again assuming that the current frame being processed is frame t, in operation 202, the processor may generate a third input by reprojecting, according to a view point of the current frame, a result obtained by adding an initial image 223 rendered in the prior frame to an image that is one of (selected between) (i) the first input and (i) the second input generated when processing the prior frame. For example, referring to FIG. 2, the processor may generate a second history image of the current frame by reprojecting, onto the view point of the current frame, a result obtained by adding the initial image 223 to the second history image 225 included in/as the second input of the prior frame. The processor may generate the third input including the second history image of the current frame.

In operation 203, the processor may generate a fourth input by reprojecting, onto the view point of the current frame, an image that is whichever of (i) the first input and (ii) the second input (generated in the prior frame) was not used to generate the third input by reprojection. For example, referring to FIG. 2, the processor may generate a first history image of the current frame by reprojecting the first history image 221 of the prior frame onto the view point of the current frame, and may generate the fourth input including the first history image of the current frame.

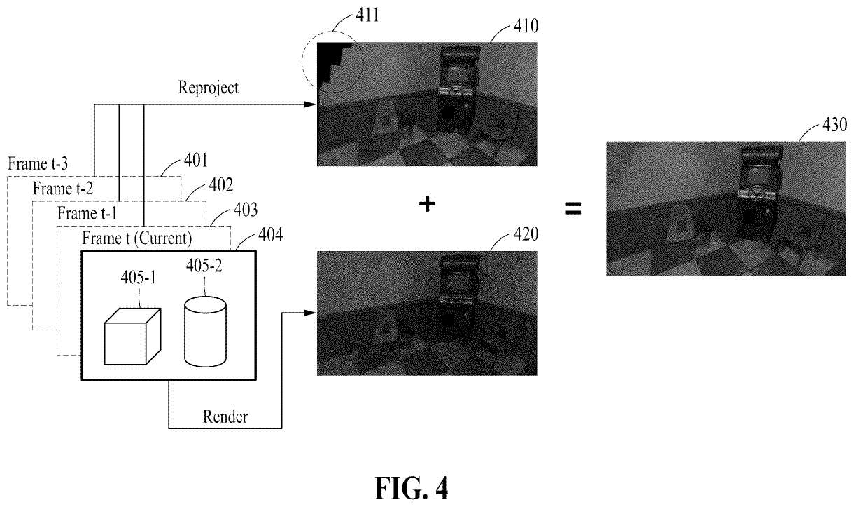

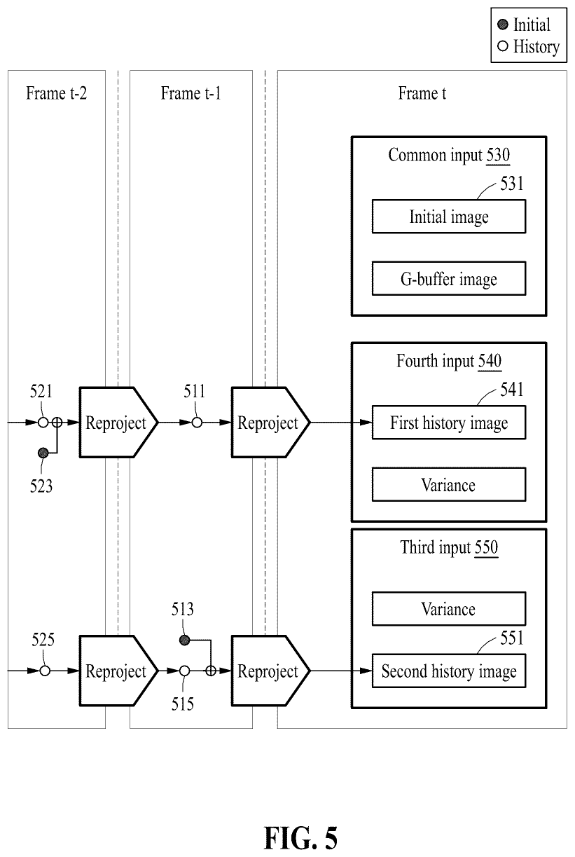

The first history image or the second history image of each frame may be an image generated by adding the first history image or the second history image included in the frame's prior frame to the initial image included in the prior frame and then reprojecting the result onto the frame's view point. The method of generating the first history image and the second history image of each frame is with reference to FIGS. 4 and 5.

In operation 204, the processor may estimate variance. Specifically, the processor may estimate variance using the first history image and the second history image of the current frame. The variance may be used later as an input when performing the linear regression analysis and the block reconstruction. More specifically, the variance may be used to optimize parameters (e.g., weights) when later performing the linear regression analysis and the block reconstruction.

Specifically, the variance \hat{σ}ₙ may be estimated by Equation 1 using the first history image and the second history image, which are color images reprojected onto the current frame (according to the viewpoint of the current frame).

$${\hat{σ}}_{n} = {( {History1}_{n} - {History2}_{n} )}^{2} \qquad Equation 1$$

Here, n denotes an index of pixels included in a history image. In other words, the variance may be calculated for each of pixels included in a history image.

The third input and the fourth input of the current frame may include the estimated variance. In other words, the third input may include the variance and one, or the other, of the first history image and the second history image. The fourth input may include the variance and whichever of the first history image and the second history image was not included in the third input. Referring to FIG. 2, in the current frame, the third input may include the second history image and the variance, and the fourth input may include the first history image and the variance.

In operation 205, the processor may perform the linear regression analysis using, as inputs, the common input, the third input, and the fourth input of the current frame. The processor may obtain linear regression coefficients for linear regression models through the linear regression analysis.

In operation 207, the processor may calculate a bandwidth by inputting an input including the common input and the first history image of the current frame to the neural network. For example, referring to FIG. 2, since the fourth input includes the first history image, the processor may input the fourth input, along with the common input, to the neural network.

The neural network may have a U-Net structure. The neural network may have a truncated U-Net (U-Net) structure in which portions of an upsampling layer and a convolutional layer are removed. When the neural network has a truncated U-Net structure, the time of performing inference and backpropagation may be reduced.

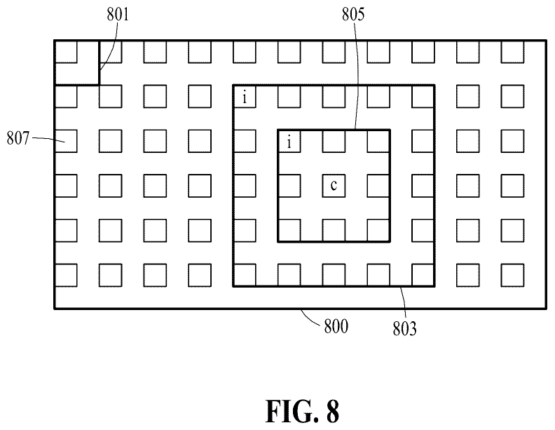

In operation 208, the processor may perform the block reconstruction using the linear regression coefficients and bandwidths for the linear regression models. As will be described with reference to FIG. 8, a linear regression model may generate an output for pixels (i.e., blocks). At this time, a total number of pixels to be output may vary depending on a size of a block reconstruction window. Therefore, the number of pixels (i.e., the number of blocks) that may be output by one linear regression model may be adjusted, and this may be referred to as block reconstruction. The processor may generate a target image through the block reconstruction. The target image may be an image from which noise has been removed.

In operation 206, the processor may perform the linear regression analysis using, as inputs, the common input, the third input, and the fourth input of the current frame. The processor may obtain linear regression coefficients for linear regression models through the linear regression analysis. However, an independent variable and a dependent variable may be set different from those in operation 207, and therefore, the linear regression coefficients obtained in operation 207 may be different from the linear regression coefficients obtained in operation 206.

In operation 209, the processor may perform the block reconstruction using the linear regression coefficients and bandwidths for the linear regression models. The processor may generate a reference image through the block reconstruction. Specifically, in operation 209, unlike in operation 208, the processor may perform the block reconstruction using a preset constant instead of the bandwidth calculated through the neural network. Accordingly, the generated reference image may be an image from which noise has not been removed.

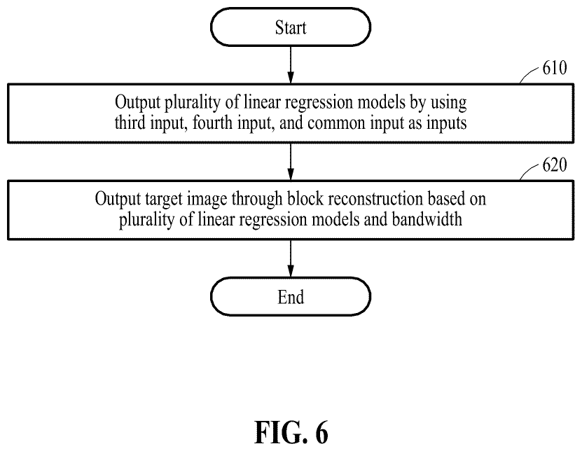

The linear regression analysis and the block reconstruction will be further described with reference to FIGS. 6 to 8.

In operation 210, the processor may calculate a loss using the target image and the reference image.

In operation 211, the processor may update the neural network using the loss. The processor may update the neural network by backpropagating the loss through the neural network. The updated neural network may be used to generate a target image in a next frame (i.e., a frame t+1).

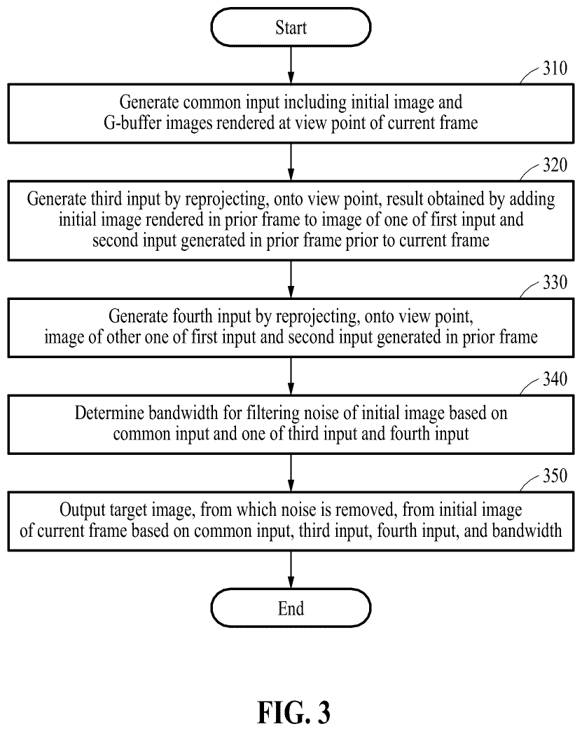

FIG. 3 illustrates example operations of an electronic device, according to one or more embodiments.

Operations 310 to 350 may be performed by the host processor 110, however, example are not limited thereto and some or all of the operations may be performed by the accelerator 130.

In operation 310, the processor may generate a common input including an initial image and G-buffer images rendered according to a view point of a current frame.

The processor may generate the common input using ray tracing.

In operation 320, the processor may generate a third input by reprojecting, onto the view point of the current frame, a result obtained by adding (i) an initial image rendered in a prior frame to (ii) an image of one of either a first input generated the prior frame (of the current frame) or a second input generated in the prior frame (of the current frame).

In other words, in a case of generating the third input, the processor may generate the third input by adding an initial image to a history image included in images of one of the first input and the second input of the prior frame (among the images of the prior frame), and reprojecting a result thereof onto the view point of the current frame.

Here, the initial image of the prior frame may be an image (i) of objects included in a 3D scene of the prior frame and (ii) that is rendered at the view point of the prior frame.

In operation 330, the processor may generate a fourth input by reprojecting, onto the view point of the current frame, an image of whichever of the first input and the second input (generated in the prior frame) was not used in operation 320.

In other words, when the third input is generated using the first input in operation 320, the image of the other one (used in operation 330) may be the second input. When the other image is the image of the second input, the processor may generate the fourth input by reprojecting, onto the view point of the current frame, a second history image of the prior frame among the images.

When the third input is generated using the second input in operation 320, the image of the other one (used in operation 330) may be the first input. When the image of the other one is the image of the first input, the processor may generate the fourth input by reprojecting, onto the view point of the current frame, a first history image of the prior frame among the images.

The first history image and the second history image of the prior frame may be images in which images of frames prior to the prior frame are accumulated.

In operation 340, the processor may determine a bandwidth to be used for filtering noise of the initial image, and the bandwidth may be determined based on the common input and one, or the other, of the third input and the fourth input.

In operation 350, the processor may output a target image obtained by removing noise from an initial image of the current frame based on the common input, the third input, the fourth input, and the bandwidth.

Next, the history image and a method of generating the history images of the current frame will be described.

FIG. 4 illustrates an example of reprojection, according to one or more embodiments.

FIG. 4 shows a history image 410 and an initial image 420.

In FIG. 4, frame t 404 may be a current frame. The initial image 420 may, as shows, be an image of objects 405-1 and 405-2 included in a 3D scene of the frame t, the image being rendered at a view point of the current frame. Accordingly, the initial image 420 may not have a blank area 411, unlike the history image 410.

The history image 410 may be a history image of the frame t 404, which is the current frame. In other words, the history image 410 may be an image in which initial images of frames prior to the frame t 404 are reprojected onto the view point of the frame t using a motion vector and then accumulated as a history image.

In this case, the view point of each frame may be different. That is, the view point of the current frame and the view point of the prior frame may be different from each other (e.g., they may be different points of view in the 3D scene being rendered). Accordingly, when an image reprojected onto the view point of the frame t 404, which is the current frame, is accumulated, the blank area 411 may be generated.

When the history image 410 and the initial image 420 are accumulated, the blank area 411 may be partially filled within an accumulated image 430. Also, compared to the initial image 420, the accumulated image 430 may have some noise removed.

A method of generating the first history image and the second history image of the current frame using the reprojection and the accumulation is described next.

FIG. 5 illustrates an example of generating a history image of a current image, according to one or more embodiments.

FIG. 5 shows a common input 530, a fourth input 540, and a third input 550. The common input 530 in a current frame (the frame t) may include an initial image 531 and G-buffer images. The fourth input 540 may include a first history image 541 and a variance. The third input 550 may include a second history image 551 and a variance. Accordingly, since all the initial image 531, the first history image 541, and the second history image 551 are color images, each of the fourth input 540 and the third input 550 may include a history image in which color images of frames prior to the current frame are accumulated.

Each of initial images 523, 513, and 531 of the respective frames may be an image of objects included in a 3D scene of each frame; each image being rendered at a respective view point of its corresponding frame. The initial image, the first history image, and the second history image of each frame may be color (e.g., RGB) images. A variance (i.e., a delta) included in the input of each frame may be calculated from the first history image and the second history image of each frame.

Next, a history image that was inputted to a neural network in each frame will be defined as the first history image, and a history image that was not inputted to a neural network will be defined as the second history image. In addition, an input including the first history image in a prior frame (prior with respect to the current frame) will be defined as a first input, and an input including the second history image will be defined as a second input. Accordingly, each of the third input and the fourth input generated in the current frame may potentially be either of the first input or the second input based on a next frame.

In each frame, the first history image and the second history image may be generated. The first history image and the second history image of each frame may be added to the initial image of each frame alternately for each frame, and then reprojected to the view point of the next frame of each frame using a motion vector. In other words, information on the first history image and the second history image of each frame may be transmitted to the next frame together with the initial image of each frame.

Referring to FIG. 5, the processor may generate the third input by reprojecting, onto the view point of the current frame (frame t), a result obtained by adding a history image included in images of one, or the other, of the first input and the second input generated in the prior frame (frame t−1) to an initial image rendered in the prior frame. The processor may generate the fourth input by reprojecting onto the view point of the current frame (frame t), a history image included in images of the other one of the first input and the second input generated in the prior frame.

For example, referring to FIG. 5, the first history image 541 may be an image obtained by reprojecting a first history image 511 of the prior frame (frame t−1) onto the view point of the current frame (frame t) using a motion vector. In addition, the second history image 551 may be an image obtained by reprojecting, onto the view point of the current frame (frame t), a result obtained by adding the initial image 513 to a second history image 515 of the prior frame (frame t−1) using a motion vector.

Similarly, the first history image 511 of the prior frame (frame t−1) may be an image obtained by reprojecting, onto the view point of the prior frame (frame t−1), a result obtained by adding the initial image 523 to a first history image 521 of a prior-prior frame (frame t−2) using a motion vector. The second history image 515 of the prior frame (frame t−1) may be an image obtained by reprojecting a second history image 525 of the frame t−2 onto the view point of the prior frame (the frame t−1).

Next, a method of generating the target image and the reference image using the input including the history image generated through the above method will be described.

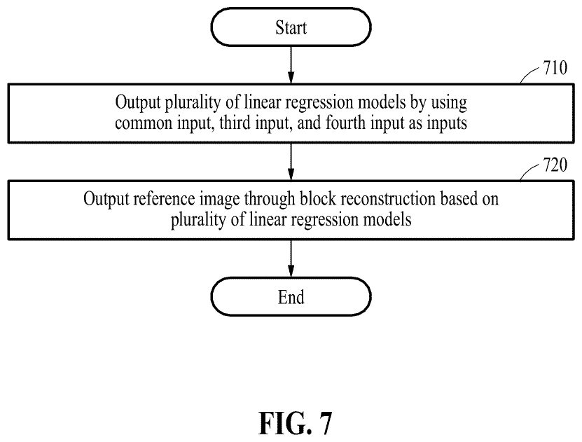

FIGS. 6 and 7 illustrate examples of generating a target image and a reference image, according to one or more embodiments.

Operations 610 and 620 and operations 710 and 720 may be performed by the host processor 110, however, example are not limited thereto and some or all of the operations may be performed by the accelerator 130.

In operation 610, the processor may output linear regression models by using the third input, the fourth input, and the common input as inputs.

The processor may output a linear regression coefficient \hat{β}_{c} for each of the linear regression models by Equation 2.

$${y}_{c} = {X}_{c} {\hat{β}}_{c} \qquad Equation 2$$

That is, the processor may output the linear regression coefficient \hat{β}_{c} that most accurately describes a relationship between a dependent variable y_{c} and an independent variable X_{c}. y_{c} is a matrix for an image obtained by adding the initial image to the first history image of the current frame and may have a size of N× 1. In this case, the initial image and the first history image may be added by applying weights so that the added image does not become too bright (e.g., the weights may be 0.5 and 0.5).

X_{c} is a matrix for the G-buffer images of the common input and the second history image of the second input and X_{c} may have a size of N×(P+3). P indicates the number of G-buffer images. 3 indicates that the second history image is an RGB image having three channels. N indicates the number of pixels included in a regression window, and a size of the regression window may determine the number of pixels used for fitting of a regression model. Therefore, if the size of the regression window is 5×5, N may be 25. The size of the regression window is further described with reference to FIG. 8.

The linear regression coefficient \hat{β}_{c} may have a size of (P+3)×1. The processor may estimate the linear regression coefficient \hat{β}_{c} using weighted least squares of Equation 3.

$${argmin}_{β} {‖ {W}_{c}^{\frac{1}{2}} ( {y}_{c} - {X}_{c} β ) ‖}^{2} \qquad Equation 3$$

y_{c} and X_{c} are the same as in Equation 2. W_{c} is a weight matrix. The weight matrix W_{c} has a size of N×N. An i-th diagonal element of the weight matrix W_{c} may be determined as

$${ω}_{ci} = exp ( - \frac{{‖ History {X}_{i} - {History X}_{c} ‖}_{2}^{2}}{{\hat{σ}}_{i}^{2} + ∈} ) .$$

i is an index of a neighboring pixel based on the regression window. C is an index of a center pixel based on the regression window. Accordingly, σᵢ is a variance of a neighboring pixels based on the regression window. ϵ is a constant, for example, 1*e⁻⁵.

x in HistoryXᵢ and HistoryX_{c}, may vary depending on which of either the first history image or the second history image the linear regression coefficient is obtained for. For example, in operation 205 of FIG. 2, X may be 1, and in operation 206, X may be 2.

In operation 620, the processor may output a target image through block reconstruction based on linear regression models and a bandwidth.

The processor may calculate a pixel value ŷ_{c} of each pixel included in an image (from which noise is removed) by Equation 4 based on a linear regression coefficient of each of the linear regression models and bandwidth \hat{b}_{c}. That is, the processor may calculate a pixel value of the target image by Equation 4.

$${\hat{y}}_{c} = \frac{1}{{\sum }_{i ∈ {Ω}_{c}} {w}_{c i}} {\sum }_{i ∈ {Ω}_{c}} {w}_{c i} {\hat{β}}_{i}^{T} {x}_{c} \qquad Equation 4$$

x_{c} is a matrix for G-buffer images and may have a size of P×1.

w_{ci} is a weight and may be expressed as

$${w}_{c i} = exp ( - {\hat{b}}_{c} log ( 1 + \frac{{‖ History {X}_{i} - {History X}_{c} ‖}_{2}^{2}}{{\hat{σ}}_{i}^{2} + ϵ} ) ) .$$

X in HistoryXᵢ and HistoryX_{c} may vary depending on which of the first history image or the second history image the linear regression coefficient is obtained for. For example, in operation 208 of FIG. 2, X may be 1, and in operation 209, X may be 2. The bandwidth \hat{b}_{c} is a bandwidth for filtering noise of the initial image output by a neural network. ϵ is a constant, for example, 1*e⁻⁵.

Ω_{c} is a block reconstruction window in which the block reconstruction is to be performed. The block reconstruction window is described with reference to FIG. 8. i is an index of a neighboring pixel based on the block reconstruction window. c us an index of a center pixel based on the block reconstruction window. Therefore, c and i in Equation 4 are indices based on the block reconstruction window, which may be different from Equation 3, which uses an index based on the regression window. Therefore, σᵢ in Equation 4 is a variance of a neighboring pixel based on the block reconstruction window.

Referring to Equation 4, to calculate a pixel value of a center pixel of the block reconstruction window, a regression model coefficient \hat{β}ᵢ of a regression model corresponding to a neighboring pixel of the block reconstruction window may be used as well as a regression model coefficient \hat{β}_{c} of a regression model corresponding to a center pixel of the block reconstruction window.

Since the generated target image reflects the bandwidth for filtering noise of the initial image output by the neural network, it may be an image, from which a noise is removed, as compared to the reference image described below.

Next, a method of calculating a reference image is described with reference to FIG. 7.

The processor may output a reference image for comparison with a target image based on the common input, the third input, and the fourth input.

In operation 710, the processor may output linear regression models by using the common input, the third input, and the fourth input as inputs.

The processor may output the linear regression models by Equation 2 as described above in operation 610.

Meanwhile, in operation 710, y_{c} is a matrix for an image obtained by adding the second history image to the initial image of the current frame and y_{c} may have a size of N× 1.

X_{c} is a matrix for the G-buffer images of the common input and the first history image of the first input and may have a size of N× (P+3).

A linear regression coefficient \hat{β}_{c} may have a size of (P+3)×1. The processor may estimate the linear regression coefficient \hat{β}_{c} using weighted least squares of Equation 3.

In operation 720, the processor may output a reference image through block reconstruction based on linear regression models.

The processor may calculate a pixel value of the reference image by Equation 4 as described above in operation 620.

Meanwhile, in operation 720, the bandwidth output through the neural network is not reflected when the reference image is output. Therefore, since the bandwidth output from the neural network is not used, a predetermined constant, rather than the bandwidth, may be input to \hat{b}_{c} of a weight w_{ci}.

FIG. 8 illustrates an example of a linear regression model and a block size used for block reconstruction, according to one or more embodiments.

FIG. 8 shows an image 800 and a linear regression model 807. FIG. 8 also shows a sparsity block 801, a regression window 803, and a block reconstruction window 805, which are three blocks that may be used in the present disclosure.

In FIG. 8, each of small squares may be a linear regression model which matches to a pixel which matches to a corresponding small square.

The number of linear regression models may be determined based on the size of the image 800 and the size of the sparsity block 801. The number of linear regression models to be fitted may be determined according to the size of the sparsity block 801. In other words, the sparsity block 801 may relate to how densely the linear regression analysis is to be performed on the image 800.

Referring to FIG. 8, the size of the sparsity block 801 may be 2×2, for example. The size of the image may be 22×16, for example, and the number of linear regression models may be determined as 88, for example, which is 22/2×16/2. Accordingly, the processor may output linear regression coefficients for 88 linear regression models.

As the size of the sparsity block 801 increases, the number of linear regression models may decrease. In this case, the operation time may be reduced due to the decrease of the number of linear regression models. As the size of the sparsity block 801 decreases, the number of linear regression models may increase. Accordingly, the operation time may increase due to the increase of the number of the linear regression models.

As the number of linear regression models increases, the noise of the target image may be more successfully removed. In other words, as the size of the sparsity block decreases, the noise of the target image may be further reduced. Accordingly, there may be a trade-off relationship between (i) the noise removal performed on the target image according to the size of the sparsity block 801 and (ii) the operation time.

The size of the regression window 803 may indicate how many pixels to use for fitting the linear regression model. For example, when the size of the regression window 803 is 9×9, a total of 81 pixels may be used to fit a linear regression model which matches to a center pixel c of the regression window. That is, in Equation 2 of FIG. 6, N may be 81.

The size of the block reconstruction window 805 may indicate a total number of pixels the linear regression model, which matches to the center pixel c, generates outputs for. In other words, one linear regression model may output values for the pixels according to the size of the block reconstruction window 805. For example, when the block reconstruction window 805 has a size of 5×5, a linear regression model denoted by c may generate outputs for a total of 25 pixels. That is, the linear regression model may also generate outputs for pixels used for fitting and other pixels.

When the pixel value which matches to the corresponding linear regression model is a center pixel, the linear regression model may be used to generate a pixel value. Also, not only the linear regression model which matches to the pixel serving as the center pixel may be used to generate a pixel value, but also linear regression models included in the block reconstruction window 805 may be used to generate a pixel value.

As the size of the block reconstruction window 805 increases, more regression models may be used. Therefore, a noise of an image output through the block reconstruction may be reduced. However, as the size of the block reconstruction window 805 increases, pixels less related to the center pixel and a regression model less related to the center pixel may be used, and a loss may increase.

The size of the block reconstruction window 805 may be equal to or larger than the size of the sparsity block to completely cover the image without a hole. Also, the size of the block reconstruction window 805 may be greater than, smaller than, or equal to the size of the regression window 803.

The regression window 803 and block reconstruction window 805 described above may have odd horizontal and vertical lengths in order to have an exact center pixel.

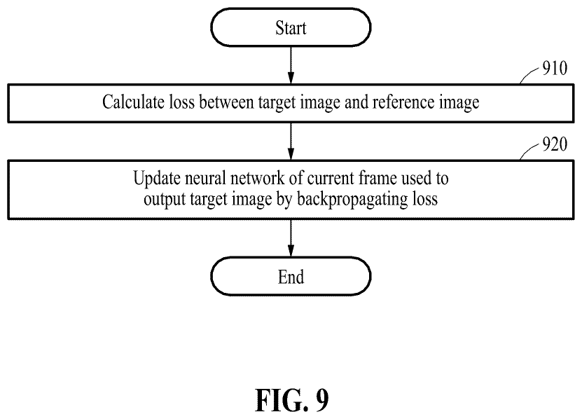

FIG. 9 illustrates an example of updating a neural network, according to one or more embodiments.

Operations 910 and 920 may be performed by the host processor 110, however, example are not limited thereto and some or all of the operations may be performed by the accelerator 130.

In operation 910, the processor may calculate a loss between the target image and the reference image.

That is, the processor may estimate the loss, which is an objective function of a neural network, without a ground truth image. In other words, the reference image may be used instead of a ground truth image to estimate the loss.

In operation 920, the processor may update a neural network of the current frame used to output the target image by backpropagating the loss.

The updated neural network of the current frame may be used to output the target image in a frame subsequent to the current frame. In other words, the neural network updated in the frame t may be used to output the target image in the frame t+1.

A neural network trained by pre-supervised learning using a separate training data set may output an image, from which noise is removed, when an image similar to the training data set is inputted to the neural network. However, the neural network of the present disclosure may be updated in each frame, for example, thus training the neural network in real time without needing pre-supervised learning, and thereby outputting an image from which a noise is removed.

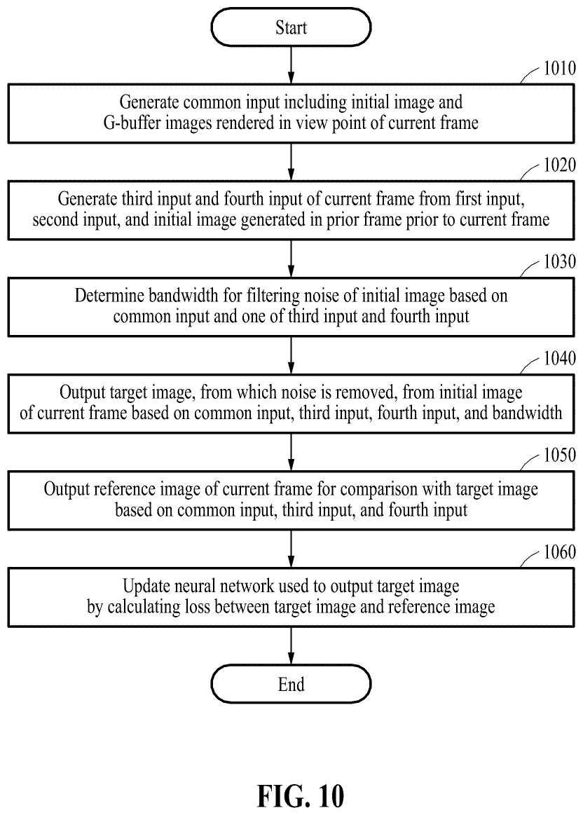

FIG. 10 illustrates an example of an electronic device, according to one or more embodiments.

Operations 1010 to 1040 may be performed by the host processor 110, however, example are not limited thereto and some or all of the operations may be performed by the accelerator 130.

In operation 1010, the processor may generate a common input including an initial image and G-buffer images rendered at a view point of a current frame.

In operation 1020, the processor may generate a third input and a fourth input of the current frame from a first input, a second input, and an initial image generated in a prior frame prior to the current frame.

In operation 1030, the processor may determine a bandwidth for filtering noise of the initial image based on the common input and one of the third input and the fourth input.

In operation 1040, the processor may output a target image obtained by removing the noise from the initial image of the current frame based on the common input, the third input, the fourth input, and the bandwidth.

In operation 1050, the processor may output a reference image of the current frame for comparison with the target image based on the common input, the third input, and the fourth input.

In operation 1060, the processor may update a neural network used to output the target image by calculating a loss between the target image and the reference image.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described herein are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of operating an electronic device comprising processing hardware and storage hardware, the method comprising:
generating, by the processing hardware, and storing in the storage hardware, a common input comprising an initial image and geometry buffer (G-buffer) images rendered according to a view point of a current frame;
generating, by the processing hardware, and storing in the storage hardware, a third input by reprojecting, onto the view point, a result obtained by adding an initial image, that is rendered in a prior frame that is prior to the current frame, to a first image, wherein the first image is one of a first input generated in the prior frame and a second input generated in the prior frame;
generating, by the processing hardware, and storing in the storage hardware, a fourth input by reprojecting, onto the view point, a second image, wherein the second image is whichever of the first input and the second input is not the first image;
determining, by the processing hardware, a bandwidth, wherein the determining of the bandwidth is based on the common input and one of the third input or the fourth input; and
outputting, by the processing hardware, and storing in the storage hardware, a target image obtained by removing noise from the initial image of the current frame based on the common input, the third input, the fourth input, and the bandwidth.

2. The method of claim 1, wherein each of the third input and the fourth input comprises a respective history image in which images of frames prior to the current frame are accumulated.

3. The method of claim 1, wherein the view point of the current frame is different from a view point of rendering the prior frame.

4. The method of claim 1, wherein the outputting of the target image comprises:
outputting, by the processing hardware, and storing in the storage hardware, linear regression models using the third input, the fourth input, and the common input as inputs; and
outputting, by the processing hardware, and storing in the storage hardware, the target image through block reconstruction based on the linear regression models and the bandwidth.

5. The method of claim 1, further comprising:
outputting, by the processing hardware, and storing in the storage hardware, a reference image for comparison with the target image, wherein the outputting the reference image is based on the common input, the third input, and the fourth input.

6. The method of claim 5, wherein the outputting of the reference image comprises:
outputting, by the processing hardware, and storing in the storage hardware, linear regression models using the common input, the third input, and the fourth input as inputs; and
outputting, by the processing hardware, and storing in the storage hardware, the reference image through block reconstruction based on the linear regression models.

7. The method of claim 6, further comprising:
calculating, by the processing hardware, and storing in the storage hardware, a loss between the target image and the reference image; and
updating, by the processing hardware, and storing in the storage hardware, a neural network of the current frame used to output the target image, wherein the updating is performed by backpropagating the loss,
wherein the neural network of the current frame outputs the bandwidth.

8. The method of claim 7, wherein the updated neural network of the current frame is used to output a target image of a next frame in the next frame of the current frame.

9. The method of claim 5, wherein the target image is an image, from which noise is removed, compared to the reference image.

10. The method of claim 4, wherein the outputting of the linear regression models comprises:
determining a number of the linear regression models based on a size of the initial image of the common input and a size of a sparsity block, and outputting linear regression coefficients for the linear regression models, respectively.

11. The method of claim 10, wherein the noise of the target image is further reduced as the size of the sparsity block decreases.

12. The method of claim 4, wherein the outputting of the target image through the block reconstruction comprises:
outputting, by the processing hardware, and storing in the storage hardware, the target image based on a size of a block reconstruction window indicating a number of pixels to be output by one linear regression model.

13. A method of operating an electronic device comprising processing hardware and storage hardware, the method comprising:
generating, by the processing hardware, and storing in the storage hardware, a common input comprising an initial image and geometry buffer (G-buffer) images rendered according to a view point of a current frame;
generating, by the processing hardware, and storing in the storage hardware, a third input and a fourth input of the current frame from a first input, a second input, and an initial image generated in a prior frame that is prior to the current frame;
determining, by the processing hardware, and storing in the storage hardware, a bandwidth for filtering a noise of the initial image, wherein the determining is based on the common input and one of the third input and the fourth input;
outputting, by the processing hardware, and storing in the storage hardware, a target image obtained by removing noise from the initial image of the current frame based on the common input, the third input, the fourth input, and the bandwidth;
outputting, by the processing hardware, and storing in the storage hardware, a reference image of the current frame for comparison with the target image, wherein the outputting is based on the common input, the third input, and the fourth input; and
updating a neural network used to output the target image, wherein the updating is performed by calculating a loss between the target image and the reference image.

14. An electronic device comprising:
one or more processors; and
storage storing instructions configured to cause the one or more processors to:
generate a common input comprising an initial image and geometry buffer (G-buffer) images rendered according to a view point of a current frame;
generate a third input by reprojecting, onto the view point, a result obtained by adding an initial image, which is rendered in a prior frame that is prior to the current frame, to a first image that is one of a first input generated in the prior frame or a second input generated in the prior frame;
generate a fourth input by reprojecting, onto the view point, a second image that is of whichever of the first input and the second input generated in the prior frame is not the first image;
determine a bandwidth based on the common input and one of the third input or the fourth input; and
output a target image obtained by removing noise from the initial image of the current frame based on the common input, the third input, the fourth input, and the bandwidth.

15. The electronic device of claim 14, wherein
each of the third input and the fourth input comprises a respective history image in which images of frames prior to the current frame are accumulated.

16. The electronic device of claim 14, wherein the view point of the current frame differs from a view point of the prior frame.

17. The electronic device of claim 14, wherein the instructions are further configured to cause the one or more processors to:
output linear regression models using the third input, the fourth input, and the common input as inputs; and
output the target image through block reconstruction based on the linear regression models and the bandwidth.

18. The electronic device of claim 14, wherein the instructions are further configured to cause the one or more processors to:
output a reference image for comparison with the target image based on the common input, the third input, and the fourth input.

19. The electronic device of claim 18, wherein the instructions are further configured to cause the one or more processors to:
output linear regression models using the common input, the third input, and the fourth input as inputs; and
output the reference image through block reconstruction based on the plurality of linear regression models.

20. The electronic device of claim 19, wherein the instructions are further configured to cause the one or more processors to:
calculate a loss between the target image and the reference image; and
update a neural network of the current frame used to output the target image by backpropagating the loss, and
wherein the neural network of the current frame outputs the bandwidth.
